(19) United States
(12) Patent Application Publication
(10) Pub. No.: US 2016/0110046 A1
(43) Pub. Date: Apr. 21, 2016

(54) ADJUSTABLE TIMELINE USER INTERFACE

(71) Applicant: HEWLETT-PACKARD DEVELOPMENT COMPANY, L.P., Houton, TX (US)

(72) Inventor: Di YAO, Shanghai (CN)

(73) Assignee: HEWLETT-PACKARD DEVELOPMENT COMPANY, L.P., Houston, TX (US)

(21) Appl. No.: 14/778,231

(22) PCT Filed: Mar. 29, 2013
(86) PCT No.: PCT/CN2013/073509

§ 371 Date: Sep. 18, 2015

(51) Int. Cl. G06F 3/0485; G06F 3/0488

(52) U.S. Cl. CPC G06F 3/0485; G06F 3/0488

(57) ABSTRACT

Embodiments of the present invention disclose an adjustable timeline user interface for a mobile device. According to one embodiment, in response to a detected touch input on the display of the device, a zoom classification level and/or scrolling feature for the timeline interface is determined based on the number of fingers, finger movement speed, and/or finger direction associated with the touch input. Consequently, the timeline interface and associated data collection is adjusted in accordance with the determined zoom classification level and/or scrolling feature.

### BACKGROUND

The ability to provide efficient and intuitive interaction between computer systems and users thereof is essential for delivering an engaging and enjoyable user-experience. Graphical user-interfaces (GUI) are commonly used for facilitating interaction between an operating user and the computing system. Due to the continued development of mobile applications and web services, mobile users are now required to browse and navigate incredible amounts of time-related data via the graphical user interface of an associated device. For example, users may have to traverse hundreds of photos from various web albums or browse thousands of news feeds, which are now constantly being accessed using mobile applications and portable devices, However, effective organization and presentation of large data collections on these portable devices has proven difficult.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of a system implementing the adjustable timeline user interface according to an example of the present invention.

FIG. 2 is a sample screen shot of the adjustable timeline user interface and scrolling feature according to an example of the present invention.

FIGS. 3A-3C are sample screen shots of the adjustable timeline user interface and various zoom classification levels according to an example of the present invention.

FIG. 4 is a simplified flow chart of the processing steps for enabling the adjustable timeline user interface according to an example of the present invention.

FIG. 5 is another simplified flow chart of the processing steps for enabling the adjustable timeline user interface according to an example of the present invention.

### DETAILED DESCRIPTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

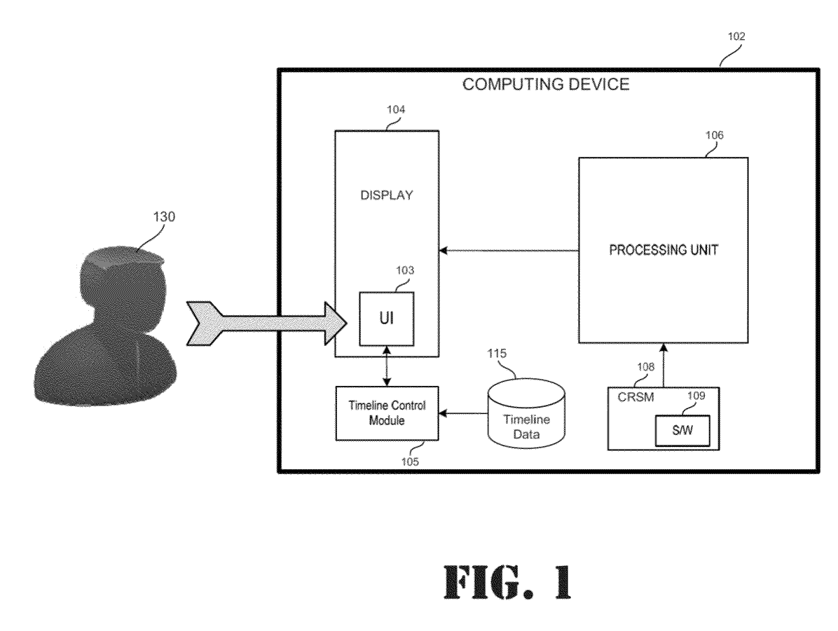

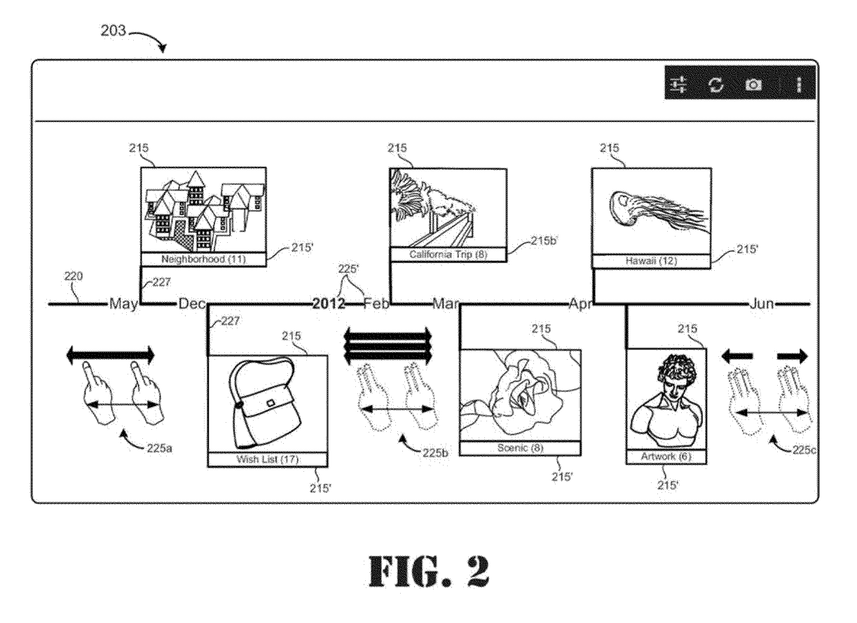

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Prior solutions attempt to organize large data collections through use of pagination or keyboard search, which only serves to increase the complexity and time to manipulate such data. Moreover, merely displaying the data in a sequence via a list or grid view does not contribute to a pleasing user experience. Still other solutions provide a scroll bar or index button for browsing large data collections. However, such input features may be suitable for navigation using standard mouse and click operations, but are not as beneficial for smaller touch screen devices (e.g., in the event the button or scroll bar is too big or small for the associated display). Accordingly, there is still a need in the art for a system that is able to quickly index copious amounts of data while providing a simple and intuitive interface for navigating data collections on a portable device.

Examples of the present invention provide a scrollable timeline interface. According to one example, the interface described herein serves to organize and present time sensitive-data vividly by creating a horizontal timeline including tagged data. Additionally, an operating user may browse the tagged data by scrolling the timeline from left to right using touch-based input. Moreover, data granularity can be specified by user such as selection of either a single photo or an album, or even a collection of data from a certain week, month, or year. As such, examples of the present invention provide a user interface capable of organizing and presenting large amounts of data on mobile device via a robust touch-based interactive design that enables effective manipulation of the data while providing an enjoyable user experience.

Referring now in more detail to the drawings in which like numerals identify corresponding parts throughout the views, FIG. 1 is a simplified block diagram of a system implementing the adjustable timeline user interface according to an example of the present invention. As shown in the present example, the system 100 includes a user 130 operating a computing device 102 such as tablet personal computing device for example. The computing device 102 includes a processing unit 106, display 104 and user interface 103, a timeline control module 105, a timeline data collection storage unit 115, and a non-transitory computer-readable storage medium 108. In one embodiment, processing unit 106 represents a central processing unit (CPU), microcontroller, microprocessor, or logic configured to execute programming instructions associated with the user interface 105. Display unit 104 represents an electronic visual display configured to display objects and a graphical user interface (GUI)103 for enabling touch input interaction between the user 130 and the computing device 102. In addition, the touch-enabled display 104 is further configured to distinguish between single finger and multiple finger input (i.e., multi-touch) from an operating user.

The timeline control module 105 communicates with the user interface 103 so as activate the timeline display and adjust the timeline based on touch input received from a user navigating the user interface 103 More particularly, and as will be further described and illustrated in the following example embodiments, the timeline control module 105 is configured to retrieve a collection of data from the database storage 115, which may include images, videos, and/or newsfeeds. The data collection may be locally stored on the computing device 102, or alternatively, the data for the timeline interface may be pulled from the internet or a cloud-based storage provider for example. Still further, storage medium 108 represents non-transitory, volatile storage (e.g. random access memory), non-volatile (e.g. hard disk drive, read-only memory, compact disc read only memory, flash storage, etc.), or combinations thereof. Moreover, storage medium 108 includes software 109 that is executable by processor 106 and, that when executed, causes the processing unit 106 to perform some or all of the functionality described herein. For example, instructions for providing the adjustable timeline user interface may be implemented as executable software within the storage medium 108.

FIG. 2 is a sample screen shot of the adjustable timeline user interface and scrolling feature according to an example of the present invention. The timeline user interface 203 is configured to display a collection of data objects to the operating user. In the present example, the timeline user interface 203 displays a plurality of photos and photo albums 215, In accordance with one example, the interface 203 includes a horizontal and centrally positioned “timeline” with the respect to the display. The timeline feature 220 may include a plurality of data tags 225, which may be used to indicate the year and month of the associated data. As illustrated, the data objects 215 and associated description information 215′ may be displayed in sequence along both upper and lower sides of the tagged timeline 220 via perpendicular branch elements 227 extending from the timeline feature 220. In the present example, the branch elements 227 are graphical features that used to provide a pleasing view and link the displayed object 215 and timeline feature 220. Furthermore, the description information 215′ indicates the name of the album in addition to the number of photos contained therein. However, the data objects may also include a newsfeed in which case the description information 215′ comprises the title of the article or publication along with a link to the source for example.

As described above with reference to FIG. 1, the touch-enabled display of the present invention is configured to distinguish single or multi-touch inputs in order to facilitate various scrolling features of the user interface. According to one example, when a single finger swipe input 225a is detected, then the timeline interface 203 may be scrolled at a speed corresponding to the movement speed of the user's fingers and touch input. Accordingly, the user is able to effortlessly browse the data collection simply by scrolling the timeline interface from left to right. On the other hand, if user scrolls or swipes the timeline using two fingers (e.g., two finger input 225b), then the timeline 220 and associated data objects 215 may be scrolled at an advanced speed related to the speed of the user's finger. For example, the timeline control module may cause the timeline interface to move at three times the finger movement speed (as indicated by multiple bi-directional arrows above 225b). Still further, and in accordance with an example embodiment, if the operating user swipes the display with three fingers (e.g., three finger input 225c), then the timeline 220 and data 215 will adjust and skip to the start or end of the timeline—based on whether the scrolling is left or right (as indicated by segmented arrows). The interactive design model of the present examples allow a user to easily and quickly find and index large data collections through multi-touch gesture and accelerated timeline scrolling features. Such a design and configuration could inspire an operating user to easily recall fond memories so as to greatly improve the mobile user-experience over existing solutions.

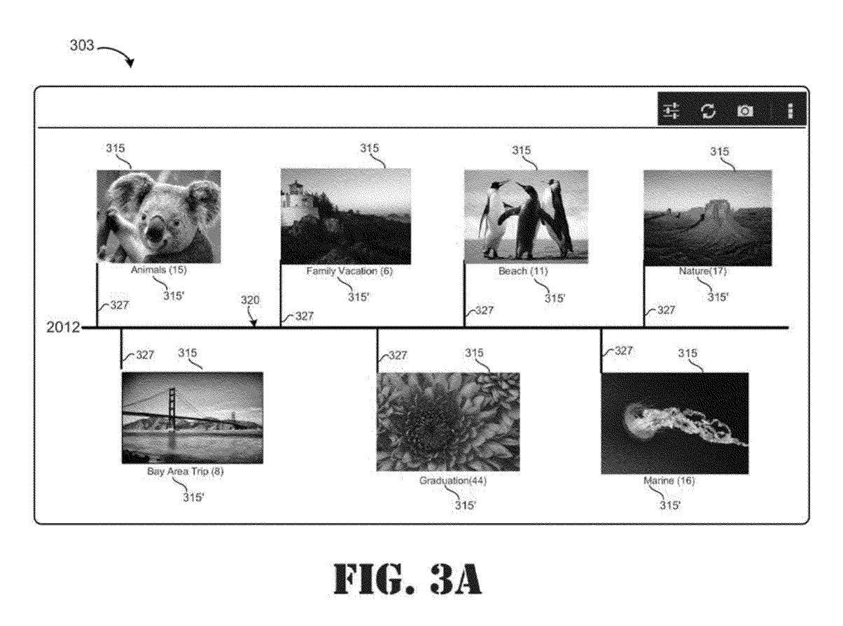

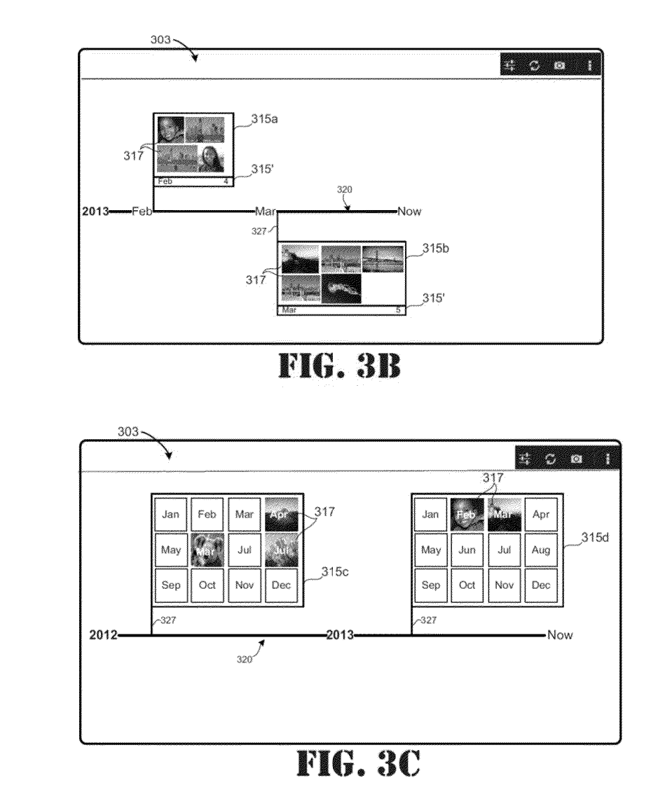

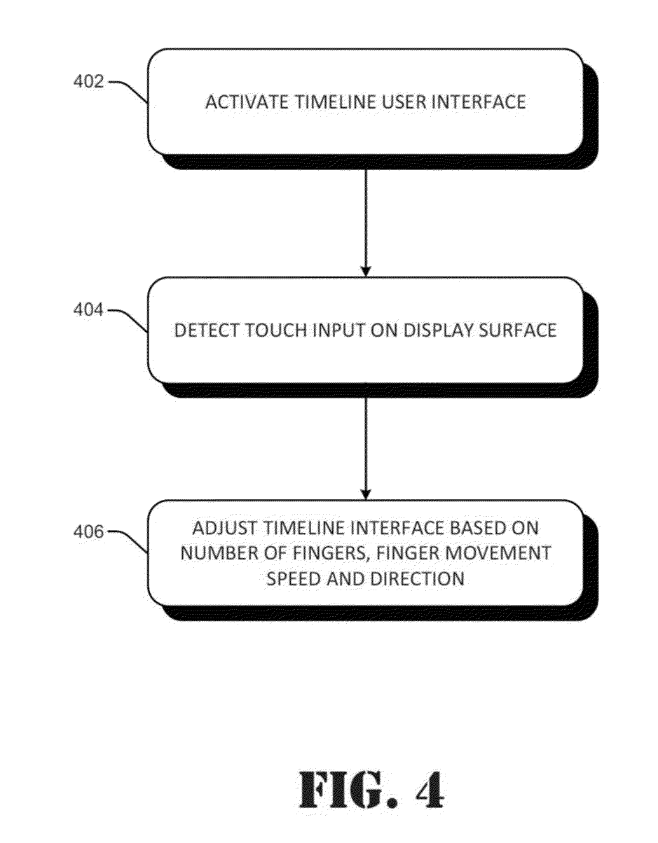

FIGS. 3A-3C are sample screen shots of the adjustable timeline user interface and various zoom classification levels according to an example of the present invention. More specifically, examples described herein enable an operating user to re-organize data collections using multiple fingers (e.g., pinch operation) so as to perform a semantic zoom of the timeline interface 303. In addition, the adjustable timeline interface allows a user's fingers to control the extent of zoom related to the shown data. FIG. 3A-3C illustrate how the data granularity can be specified by user such that a single photo or an album, or even a collection of data for a certain week, month, or year, may be quickly displayed on the adjustable timeline user interface 303. In particular, the timeline interface 303 may include three or more zoom levels in which data classifications are segmented. For example, FIG. 3A depicts the first zoom classification level in which the data objects are displayed in a flat or album view. As shown here, multiple data objects 315 (e.g., image albums) and description tags 315′ are shown on either side of the horizontal timeline feature 320 with branch elements 327 extending perpendicularly from the horizontal timeline graphic 320 in accordance with each identified data object or album. FIG. 3B depicts the user interface 303 in a second zoom classification level (e.g., zoom out). For instance, the second zoom classification level may be month view in which the displayed objects are organized and segmented into various months. As shown here, two data objects 315a and 315b are shown as photo albums containing content having February and March timestamps respectively for example. That is, the branch features 327 of the timeline graphic 320 extend along the current view of months and associated data objects. Moreover, each album 315a and 315b may include description information 315′ and thumbnails or preview images 317 associated with the content of the data object or album (e.g., 315a and 315b). FIG. 3C depicts yet another example of the present invention in which the data objects are organized by year. As shown, a third zoom classification level may cause the timeline user interface 303 to display and segment the data collection and associated objects by year. For instance, FIG. 3C illustrates two yearly album views 315c and 315d representing content having timestamps within the years “2012” and “2013” respectively. In accordance with one example embodiment, the yearly album views 315c and 315d branch from the horizontal timeline feature 320 and include months of the year along with preview images 317 for any month having data content associated therewith. Additionally, the operating user may extend the timeline from the year or month view to a single album or photo view by using two fingers to zoom-in on the display (i.e., fingers move from apart to touching). In the present examples, the preview or thumbnail content 317 is a still photographic image. However, examples of the present invention are not limited thereto as the preview image 317 may comprise of an animated still in the case of video content, or text associated with a newsfeed or publication for example.

FIG. 4 is a simplified flow chart of the processing steps for enabling the adjustable timeline user interface according to an example of the present invention. In step 402, the adjustable timeline user interface is activated by the computing device, For instance, the timeline interface may be activated by the user opening a particular mobile application on a tablet computing device. Upon activation, the timeline control module causes the graphical user interface to display the horizontal timeline feature, tag information, and branch features as described above. When a touch input is detected on the display surface of the computing device in step 404, the timeline control module causes the timeline user interface to adjust in step 406 in accordance with the number of fingers, finger movement speed, and/or finger movement direction associated with the touch input from the user.

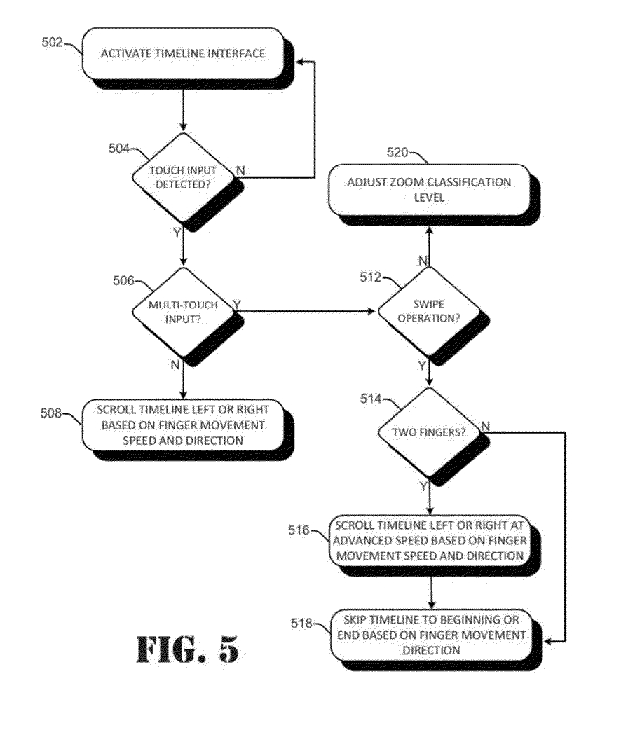

FIG. 5 is another simplified flow chart of the processing steps for enabling the adjustable timeline user interface according to an example of the present invention. In step 502, the timeline user interface is activated by the operating user through opening of a mobile application on the computing device for example. If a touch input is detected in step 504, then a determination is made as to whether or not there was a multi-touch input in step 506. If a multi-touch input (i.e., two or three fingers) is not detected and the touch input is determined to be a single finger swipe input, then in step 508 the timeline user interface is adjusted to scroll left or right based on the finger swipe movement speed and direction associated with the detected touch input. On the other hand, if the input is identified by the processing unit and user interface as a multi-touch input, then a determination is made in step 512 as to whether the input was a multi-touch swipe movement or pinch movement. If a two-finger swipe operation is detected in step 514, then in step 516 the timeline and data objects are scrolled at an advanced speed based on the finger movement speed and direction of the touch input. For example, the timeline interface may advance forward or revert backward sequentially three times the movement speed of the user's input. However, a three-fingered swipe input operation causes the timeline control module to skip the timeline interface to the beginning or end of the timeline graphic based on the direction of the touch input, For example, a left-to-right three-finger swipe may cause the timeline to skip back to the first data object of the timeline, while a right-to-left three finger swipe may cause the timeline to advance to the last date thereof On the other hand, if a non-swipe or pinch operation is detected in step 512, then the zoom classification level of the timeline interface is adjusted accordingly in step 520. For example, if the detected finger pinch is an open movement (i.e., fingers move from close to away from each other), then the zoom classification level is adjusted up in, granularity (i.e., zoom out) from the current classification level. That is, if the current zoom classification was at the album view, then the next classification level up would be a week or monthly view as described and depicted with respect to FIG. 3B. Conversely, if the pinch operation is a close movement (i.e., fingers move from away to touching), then the zoom classification level s adjusted down in granularity (i.e., zoom in). For example, the zoom classification level and timeline interface may adjust from a yearly view as shown in FIG. 3C downward in granularity to the monthly view shown in FIG. 3B for example.

Embodiments of the present invention provide an adjustable timeline user interface. Moreover, many advantages are afforded by the timeline and interface according to embodiments of the present invention. For instance, examples described herein can reduce the complexity and greatly reduce the time needed for a user to manipulate their time-sensitive data. In addition, since the scrolling and zoom features of the interface are purely touch-oriented, operating users are able to quickly access and traverse large amounts of data on a touch-enabled mobile device. Furthermore, users can navigate the data collection at varying speeds and reorganize the data based on a various classification levels.

Furthermore, while the invention has been described with respect to example embodiments, one skilled in the art will recognize that numerous modifications are possible For example, although example embodiments depict photographic images as the data objects, the invention is not limited thereto. For example, the collection of data objects may include movies, text-based documents, newsfeeds, audio files, or any other data object that may be time-stamped and capable of being organized and segmented into groupings. In addition, the timeline feature described herein may be positioned centrally and vertically as opposed to horizontally such that object data is positioned to the left and right of the timeline feature.

Not all components, features, structures, characteristics, etc, described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement o order of elements or other features illustrated in the drawings or described herein need not be arranged in the particular way illustrated and described. Many other arrangements are possible according to some embodiments.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

1. A computer-implemented method for providing an adjustable timeline interface on a device, the method comprising:
detecting touch input on a display associated with said device; and
determining, in response to said touch input, a zoom classification level and/or scrolling feature for the timeline interface based on the number of fingers, finger movement speed, and/or finger direction associated with said touch input,
wherein the timeline interface and an associated data collection is adjusted in accordance with the determined zoom classification level and/or scrolling feature.

2. The method of claim 1 further comprising
advancing the timeline forward or reverting the timeline backward based on the number of fingers and finger movement direction associated with the touch input.

3. The method of claim 1, further comprising:
adjusting the zoom classification level based on a detected pinch operation and the current zoom classification level.

4. The method of claim 2, wherein when the touch input includes a single finger swipe movement, the timeline is adjusted to scroll forward or backward at a speed corresponding to the finger movement speed.

5. The method of claim 2, wherein when the touch input includes a two finger swipe movement, the timeline is adjusted to scroll forward or backward at three times the finger movement speed.

6. The method of claim 2, wherein when the touch input includes a three finger swipe movement, the current timeline view is adjusted to skip to start or end of said timeline.

7. The method of claim 3, wherein the zoom classification level includes an album view, a month view, and year view of the data collection.

8. The method of claim 7, wherein the data collection comprises a plurality of images, videos, and/or news feeds.

9. A system for proving an adjustable timeline user interface on a portable electronic device, the system comprising:
a touch-enabled display for displaying an interactive timeline and configured to receive touch input from an operating user: and
a timeline control module configured to adjust, in response to a detected touch input, a zoom classification level and/or scrolling feature for the timeline interface and an associated data collection based on the number of fingers, finger movement speed, and/or finger direction associated with the touch input.

10. The system of claim 9, wherein the timeline advances forward or reverts backward based on the number of fingers and finger movement direction associated said touch input.

11. The system of claim 9, wherein zoom classification level of the timeline is adjusted based on a detected pinch operation and the current zoom classification level.

12. The system of claim 10, wherein a single finger swipe movement scrolls the timeline forward or backward at a speed corresponding to the finger movement speed, a two finger swipe movement scrolls the timeline forward or backward at three times the finger movement speed, and a three finger swipe movement skips to the start or end of the timeline.

13. The system of claim 11, wherein the zoom classification level includes an album view, a month view, and year view of the data.

14. The system of claim 13, wherein the data collection comprises a plurality of images, videos, and/or news feeds.

15. A non-transitory computer readable storage medium having stored executable instructions for providing an adjustable timeline user interface on a portable electronic device having a display, and that when executed by a processor, causes the processor to:
detect a touch input from a user on said display;
determine, in response to said touch input, an adjustment view of the interface timeline that enables:
scrolling the timeline forward or backward based on the number of fingers, finger movement speed, and finger movement direction associated the touch input, and
modifying the zoom classification level based on a detected pinch operation and the current zoom classification level.
